(19) United States
(12) Patent Application Publication
(10) Pub. No.: US 2021/0095803 A1
(43) Pub. Date: Apr. 1, 2021

(54) QUICK-INSERTION COUPLING JOINT

(71) Applicant: Luxe Machinery Co., Ltd., Gaoan (CN)

(72) Inventors: Xiaobin LU, Gaoan (CN); Chengyong YANG, Gaoan (CN)

(21) Appl. No.: 16/678,109

(22) Filed: Nov. 8, 2019

(30) Foreign Application Priority Data
Sep. 30, 2019 (CN) 201910939876.5

(51) Int. Cl. F16L 37/08

(52) U.S. Cl. CPC F16L 37/08

(57) ABSTRACT

The present invention discloses a quick-insertion coupling joint, where a socket is arranged in one end of a female coupler body, a seal retainer is arranged in an inner wall of the socket, a sealing gasket is arranged at the seal retainer, multiple limiting holes are arranged in a side wall of the socket, a limiting element is arranged in each limiting hole, a first boss is arranged on an outer side wall of the female coupler body, the sliding sleeve sleeves the exterior of the first boss, a coupling groove is arranged in the outer side wall of the female coupler body, a retaining ring is arranged in the coupling groove, a second boss is arranged on an inner wall of the sliding sleeve, elastic elements sleeve the exterior of the female coupler body and are arranged between the second boss and the first boss

### TECHNICAL FIELD

The present invention relates to the technical field of pipe joints, and in particular, to a quick-insertion coupling joint.

### BACKGROUND

A quick joint includes a hydraulic quick joint and various fluid quick joints, which is a quick-assembly/disassembly connector for quickly connecting or disconnecting pipelines and is widely applied to the fields of petroleum, metallurgy, hydropower, construction machinery, ship, electromechanical equipment and the like. The connecting structure of the quick joint is the most important portion of the quick joint, and its connecting manner and structure directly determines use convenience, reliability and product quality of the quick joint. As shown in FIG. 9, the existing quick joint generally includes a main body 25, handles 26 and pins 27, and its seal connection is achieved by rotating the handle to lock an arc bulge at one end of the handle into an arc groove of a male adapter. The handle occupies a large space and has a complex structure. The quick joint can be fixedly connected by strongly pressing the handle. Assembly of the quick joint wastes time and labors, and a high machining accuracy is necessary to ensure sealing performance of the quick joint. Therefore, it there is an urgent need to develop a quick joint having a simple structure, high assembly efficiency and great sealing performance.

### SUMMARY

An objective of the present invention is to provide a quick-insertion coupling joint, which has a simple structure, a compact size, and great sealing performance, and can be conveniently and quickly assembled and disassembled, in order to solve the problem in the prior art.

To achieve the above purpose, the present invention provides the following technical solution.

A quick-insertion coupling joint includes a female coupler body, a sliding sleeve, elastic elements, a sealing gasket, limiting elements and a retaining ring, where a socket is arranged in one end of the female coupler body and is used for connecting a Camlock male adapter, a seal retainer is arranged in an inner wall of the socket, the sealing gasket is arranged on one surface, close to a port of the socket, of the seal retainer, multiple limiting holes are circumferentially arranged in a side wall of the socket, a limiting element is arranged in each limiting hole, the limiting hole can limit the limiting element to prevent the limiting element from separating from the limiting hole inwards, a first boss is arranged on an outer side wall of the female coupler body, the sliding sleeve sleeves the exterior of the first boss, a coupling groove is arranged in the outer side wall of the female coupler body, the coupling groove is arranged between the port of the socket and the limiting hole, the retaining ring is arranged in the coupling groove, a second boss is arranged on an inner wall of the sliding sleeve, the second boss is arranged between the first boss and the retaining ring, the internal diameter of the second boss is less than the external diameter of the retaining ring, the elastic elements sleeve the exterior of the female coupler body while the elastic elements are arranged between the second boss and the first boss, the elastic elements are in a compression state, and a limiting groove is circumferentially arranged in an outer wall of the Camlock male adapter; when the Camlock male adapter is inserted into the socket and the second boss slides to come into contact with the retaining ring, the second boss can ensure that the limiting element is fixed in the limiting groove and the Camlock male adapter tightly presses the sealing gasket at the seal retainer; and an end face, away from the first boss, of the second boss is inclined to one end away from the first boss, so, when the second boss slides away from the limiting hole, the limiting element can be disconnected from the limiting groove.

Preferably, anti-skid mesh-shaped bulges are arranged on an outer surface of the sliding sleeve.

Preferably, a rectangular annular groove is arranged in an inner wall of the sealing gasket.

Preferably, the seal retainer is a sealing boss, the sealing gasket is arranged on one surface, close to the port of the socket, of the sealing boss, a connection port is arranged at one end, away from the socket, of the female coupler body, the connection port and the socket are interconnected, and the connection port is used for connecting a pipe fitting.

Preferably, the seal retainer is a sealing diaphragm, the sealing diaphragm seals one end, away from the socket, of the female coupler body, the sealing gasket is arranged on one surface, close to the port of the socket, of the sealing diaphragm.

Preferably, the limiting element is a limiting ball or a limiting block.

Preferably, a dust-proof boss is arranged on the inner wall of the sliding sleeve, the dust-proof boss is arranged at one end, close to the port of the socket, of the sliding sleeve, and the internal diameter of the dust-proof boss is greater than the external diameter of the socket.

Preferably, the elastic element is a spring.

Compared with the prior art, the present invention achieves the following technical effects:

The present invention provides the quick-insertion coupling joint, where the sliding sleeve is pushed by hand in order that the second boss is away from the limiting hole and the limiting element can move outwards from the limiting hole in a radial direction of the socket, the Camlock male adapter is inserted into the socket of the female coupler body and extrudes the sealing gasket, the sliding sleeve is loosened, and at this time, the sliding sleeve moves towards the limiting hole and extrudes the limiting element under the elastic action of the elastic elements such that the limiting element is fixed in the limiting groove of the Camlock male adapter, thereby preventing the Camlock male adapter from moving outwards and achieving quick connection of the joint, so the structure is simple, a little space is occupied, and sealing performance of the joint is ensured. When the female coupler body and the Camlock male adapter need to be disconnected, the female coupler body is held by hand, the sliding sleeve is pushed in order that the second boss is away from the limiting hole, at this time, the limiting element is disconnected from the second boss and moves outwards from the limiting hole in the radial direction of the socket, and after the limiting element is disconnected from the limiting groove of the Camlock male adapter, the Camlock male adapter and the female coupler body are separated, so disassembly is convenient and quick.

### BRIEF DESCRIPTION OF THE DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram showing a connecting structure of a quick-insertion coupling joint in Embodiment 1 of the present invention and a Camlock male adapter.

FIG. 2 is a schematic diagram showing a connecting structure of a quick-insertion coupling joint in Embodiment 2 of the present invention and a Camlock male adapter.

FIG. 3 is a schematic diagram showing a connecting structure of a quick-insertion coupling joint in Embodiment 3 of the present invention and a Camlock male adapter.

FIG. 4 is a schematic structural diagram of a sealing gasket in a quick-insertion coupling joint provided by the present invention.

FIG. 5 is a schematic structural diagram of a limiting hole in a quick-insertion coupling joint provided by the present invention.

FIG. 6 is a perspective view of a structure of a limiting block in a quick-insertion coupling joint provided by the present invention.

FIG. 7 is an axial sectional view of a limiting block and a limiting hole in a quick-insertion coupling joint provided by the present invention.

FIG. 8 is a radial sectional view of the limiting block and the limiting hole in the quick-insertion coupling joint in FIG. 7.

FIG. 9 is a schematic structural diagram of an existing quick joint.

In the drawings: 1—female coupler body, 2—sliding sleeve, 3—elastic element, 4—sealing gasket, 5—limiting element, 6—retaining ring, 7—Camlock male adapter, 8—seal retainer, 9—limiting hole, 10—first boss, 11—coupling groove, 12—second boss, 13—limiting groove, 14—anti-skid mesh-shaped bulge, 15—rectangular annular groove, 16—internal thread, 17—first hole, 18—second hole, 19—annular boss, 20—dust-proof boss, 21—end face, 22—tail pipe, 23—coupling bulge, 24—limiting bulge, 25—main body, 26—handle, and 27—pin.

### DETAILED DESCRIPTION

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention. An objective of the present invention is to provide a quick-insertion coupling joint, which has a simple structure, a compact size, and great sealing performance, and can be conveniently and quickly assembled and disassembled, in order to solve the problem in the prior art.

To make the foregoing objective, features, and advantages of the present invention clearer and more comprehensible, the present invention is further described in detail below with reference to the accompanying drawings and specific embodiments.

### Embodiment 1

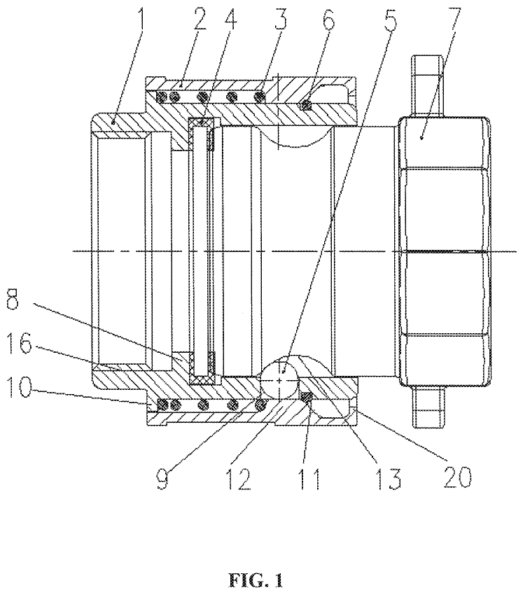

As shown in FIG. 1, the embodiment provides a quick-insertion coupling joint, which includes a female coupler body 1, a sliding sleeve 2, elastic elements or a spring 3, a sealing gasket 4, limiting elements 5 and a retaining ring 6. A socket is arranged in one end of the female coupler body 1 and is used for receiving and connecting a Camlock male adapter 7. A seal retainer 8 is arranged in an inner wall of the socket and a sealing gasket 4 is arranged on one surface of the seal retainer 8 close to a port of the socket. Multiple limiting holes 9 are circumferentially arranged in a side wall of the socket, and a limiting element 5 is arranged in each limiting hole 9. The limiting hole 9 can limit the limiting element 5 to prevent the limiting element from inwardly separating from the limiting hole 9. A first boss 10 is arranged on an outer side wall of the female coupler body 1. The sliding sleeve 2 sleeves the exterior of the first boss 10. A coupling groove 11 is arranged in the outer side wall of the female coupler body 1, and is arranged between the port of the socket and the limiting hole 9. The retaining ring 6 is arranged in the coupling groove 11. A second boss 12 is arranged on an inner wall of the sliding sleeve 2, between the first boss 10 and the retaining ring 6. The internal diameter of the second boss 12 is less than the external diameter of the retaining ring 6. The elastic elements 3 sleeve the exterior of the female coupler body 1 while the elastic elements 3 are arranged between the second boss 12 and the first boss 10. The elastic elements 3 are in a compression state and a limiting groove 13 is circumferentially arranged in an outer wall of the Camlock male adapter 7. When the Camlock male adapter 7 is inserted into the socket and the second boss 12 slides to come into contact with the retaining ring 6, the second boss 12 can ensure that the limiting element 5 is fixed in the limiting groove 13 and the Camlock male adapter 7 tightly presses the sealing gasket 4 at the seal retainer 8. An end face of the second boss 12, away from the first boss 10, is inclined to one end away from the first boss 10, such that when the second boss 12 slides away from the limiting hole 9, the limiting element 5 can be disconnected from the limiting groove 13.

When the quick-insertion coupling joint is assembled, the sliding sleeve 2 is pushed by hand in order that the second boss 12 is away from the limiting hole 9 and the limiting element 5 can move outwards from the limiting hole 9 in a radial direction of the socket and cannot be disconnected from the limiting hole 9 under the blocking action of the sliding sleeve 2. The Camlock male adapter 7 is inserted into the socket of the female coupler body 1 and extrudes the sealing gasket 4, the sliding sleeve 2 is loosened, and at this time, the sliding sleeve 2 moves towards the limiting hole 9 and extrudes the limiting element 5 under the elastic action of the elastic elements 3 such that the limiting element 5 is fixed in the limiting groove 13 of the Camlock male adapter 7, thereby preventing the Camlock male adapter 7 from moving outwards and achieving quick connection of the joint. Thus demonstrating that the structure is simple, a little space is occupied, and sealing performance of the joint is ensured. When the quick-insertion coupling joint is disassembled, the female coupler body 1 is held by hand, the sliding sleeve 2 is pushed in order that the second boss 12 is away from the limiting hole 9. At this time, the limiting element 5 is disconnected from the second boss 12 and moves outwards from the limiting hole 9 in the radial direction of the socket, and after the limiting element 5 is disconnected from the limiting groove 13 of the Camlock male adapter 7, the Camlock male adapter 7 and the female coupler body 1 are separated, so disassembly is convenient and quick. The quick-insertion coupling joint provided by the present invention can replace all kinds of Camlock female couplers, and its specification range is from ½″ to 8″, where the material of the female coupler body 1 and the sliding sleeve 2 can be aluminum alloy, copper alloy, stainless steel, carbon steel, polypropylene (PP) and the like.

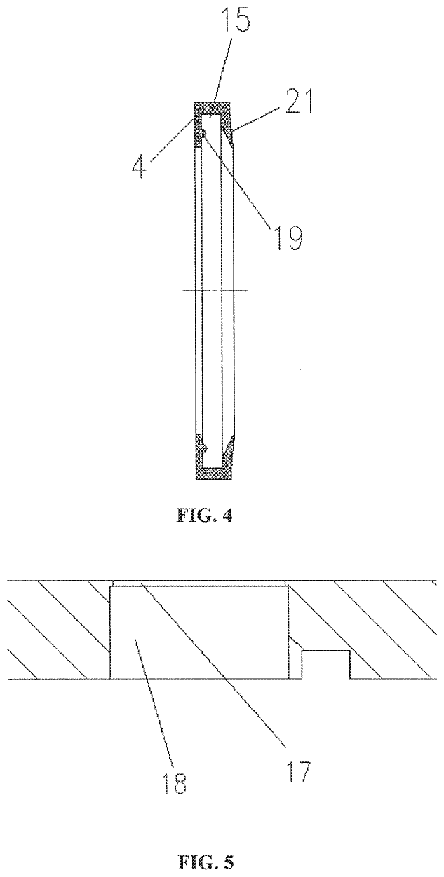

As shown in FIG. 4, a rectangular annular groove 15 is arranged in an inner wall of the sealing gasket 4. When a fluid is conveyed, a pressure difference is generated between an interior of the rectangular annular groove 15 and an exterior thereof. The fluid extrudes the sealing gasket 4 from the interior of the rectangular annular groove 15 to the exterior thereof, stressing a seal surface of the sealing gasket 4. The sealing gasket 4 is unlikely to generate leakage, and within a certain pressure range, the greater an internal pressure is, the better the sealing performance is. One end face 21 of the sealing gasket 4 is inclined outwards, such that when the internal pressure is low, the Camlock male adapter 7 extrudes the inclined end face 21 of the sealing gasket 4 such that the seal surface of the sealing gasket 4 is in extrusion contact to ensure no leakage under a low pressure. An annular boss 19 is arranged in the rectangular annular groove 15 to improve strength and elasticity of the sealing gasket 4.

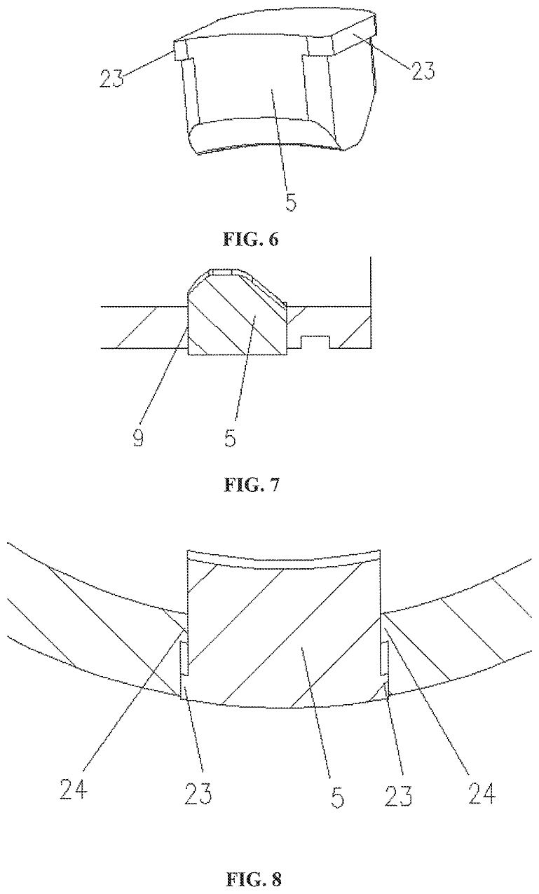

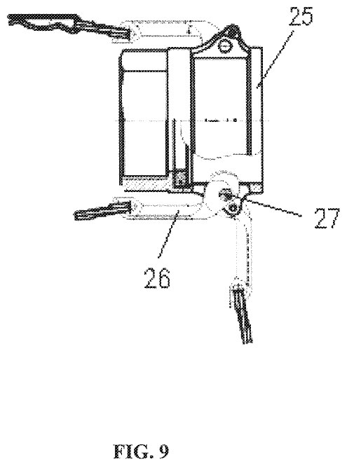

As shown in FIG. 5 to FIG. 8, the limiting element 5 is a limiting ball. The limiting ball is made of steel so as to be convenient in manufacture and low in costs. The limiting hole is a step hole when the limiting element 5 is the limiting ball. The limiting hole 9 includes a first hole 17 and a second hole 18, which are radially arranged. The first hole 17 is close to the interior in a radial direction of the second hole 18. The diameter of the first hole 17 is less than the diameter of the limiting ball such that the first hole 17 can prevent the limiting ball from inwardly separating from the limiting hole 9. However, the limiting element 5 is not limited to the limiting ball and can also be a limiting block. The limiting block can be a square limiting block with the corresponding limiting hole 9 also being a square limiting hole. The limiting block is arranged in the limiting hole 9 in a sliding manner. There is a great contact area of a side wall of the limiting block and an inner wall of the limiting hole 9 such that stress effect is great. An inclined surface is respectively arranged on two sides, in an axial direction of the socket, of one end close to the interior in a radial direction of the limiting block such that the Camlock male adapter 7 is conveniently inserted into or pulled out of the socket. A limiting bulge 24 is arranged on one side surface close to the interior in a radial direction of the limiting hole 9. A coupling bulge 23 is arranged on one side wall of one end close to the exterior in a radial direction of the limiting block, and after the limiting block slides inwards in the radial direction of the limiting hole 9 until the limiting bulge 24 and the coupling bulge 23 are in contact, the limiting bulge 24 can limit the coupling bulge 23 to prevent the coupling bulge from continuously sliding inwards.

As shown in FIG. 1, a dust-proof boss 20 is arranged on the inner wall of the sliding sleeve 2 at one end, close to the port of the socket, of the sliding sleeve 2. The internal diameter of the dust-proof boss 20 is greater than the external diameter of the socket such that the dust-proof boss 20 can prevent outside dust from entering the sliding sleeve 2.

The elastic element 3 is a spring and has a simple structure.

In the embodiment, the seal retainer 8 is a sealing boss. The sealing gasket 4 is arranged on one surface, close to the port of the socket, of the sealing boss. A connection port is arranged at one end, away from the socket, of the female coupler body 1. The connection port and the socket are interconnected, and the connection port is used for connecting a pipe fitting, where an internal thread 16 is arranged in an inner wall of the connection port. Certainly an external thread can also be arranged in an outer wall of the connection port, so the connection port is connected with the pipe fitting through the thread, which is convenient and has great sealing performance.

### Embodiment 2

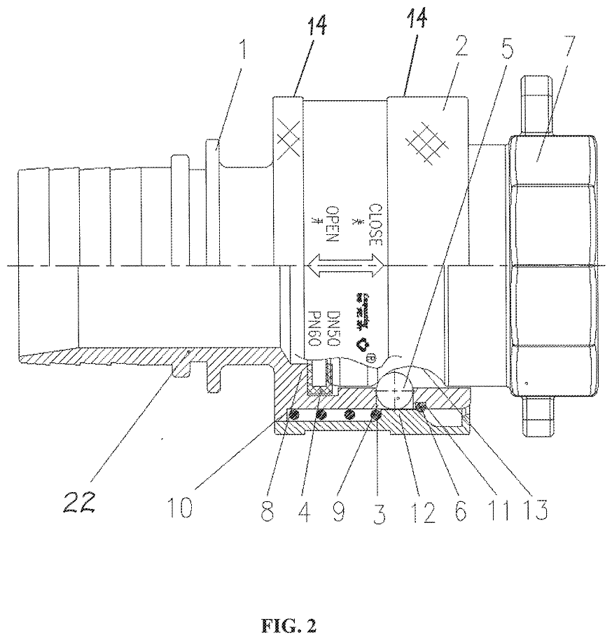

As shown in FIG. 2, the embodiment provides a quick-insertion coupling joint, and the difference from the quick-insertion coupling joint in Embodiment 1 lies in the implementation of anti-skid mesh-shaped bulges 14 arranged on an outer surface of a sliding sleeve 2 such that friction between the sliding sleeve 2 and the hand can be increased and the sliding sleeve 2 is convenient to be pushed.

Where a connection port for connecting a pipe fitting is a tail pipe 22, and the quick-insertion coupling joint is connected with the pipe fitting through the tail pipe 22.

### Embodiment 3

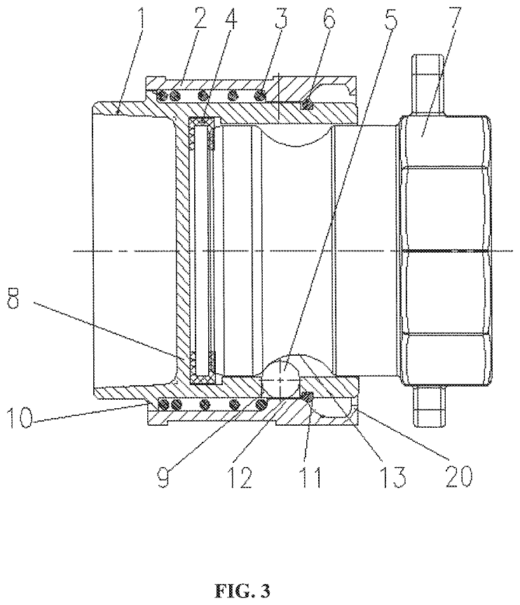

As shown in FIG. 3, in a quick-insertion coupling joint provided by the embodiment, a seal retainer 8 is a sealing diaphragm, and it seals one end, away from a socket, of the female coupler body. The sealing gasket 4 is arranged on one surface, close to a port of the socket, of the sealing diaphragm 8, and due to arrangement of the sealing diaphragm, a pipe fitting can be sealed and dust can be prevented.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

What is claimed is:

1. A quick-insertion coupling joint, comprising
a female coupler body having
a socket arranged in one end thereof for connecting a Camlock male adapter having a limiting groove circumferentially arranged in an outer wall thereof, the socket having multiple limiting holes circumferentially arranged in a side wall of the socket and a seal retainer arranged in an inner wall of the socket,
a limiting element arranged in each limiting hole such that the limiting hole prevents the limiting element from inwardly separating from the limiting hole;
a first boss arranged on an outer side wall of the female coupler;
a coupling groove arranged in the outer side wall of the female coupler between a port of the socket and one of the limiting holes;
a retaining ring arranged in the coupling groove;
a sliding sleeve sleeves an exterior of the first boss, and includes a second boss arranged between the first boss and the retaining ring, the second boss having an internal diameter that is less than an external diameter of the retaining ring;
elastic elements arranged between the second boss and the first boss and configured to sleeve an exterior of the female coupler body; and
a sealing gasket arranged on one surface of the seal retainer, close to a port of the socket,
wherein, when the Camlock male adapter is inserted into the socket and the second boss slides to come into contact with the retaining ring, the second boss ensures that the limiting element is fixed in the limiting groove and the Camlock male adapter tightly presses the sealing gasket at the seal retainer; and wherein an end face of the second boss, away from the first boss, is inclined to one end away from the first boss, such that when the second boss slides away from the limiting hole, the limiting element can be disconnected from the limiting groove.

2. The quick-insertion coupling joint according to claim 1, further comprising anti-skid mesh-shaped bulges arranged on an outer surface of the sliding sleeve.

3. The quick-insertion coupling joint according to claim 1, further comprising a rectangular annular groove arranged in an inner wall of the sealing gasket.

4. The quick-insertion coupling joint according to claim 1, wherein the seal retainer comprises a sealing boss, the sealing gasket is arranged on one surface, close to the port of the socket, of the sealing boss, a connection port is arranged at one end, away from the socket, of the female coupler body, the connection port and the socket are interconnected, and the connection port is used for connecting a pipe fitting.

5. The quick-insertion coupling joint according to claim 1, wherein the seal retainer comprises a sealing diaphragm, the sealing diaphragm seals one end, away from the socket, of the female coupler body, the sealing gasket is arranged on one surface, close to the port of the socket, of the sealing diaphragm.

6. The quick-insertion coupling joint according to claim 1, wherein the limiting element comprises a limiting ball or a limiting block.

7. The quick-insertion coupling joint according to claim 1, further comprising a dust-proof boss arranged on the inner wall of and at one end of the sliding sleeve close to the port of the socket, the dust-proof boss having an internal diameter that is greater than the external diameter of the socket.

8. The quick-insertion coupling joint according to claim 1, wherein the elastic elements comprises a spring.
